(19) United States
(12) Patent Application Publication
(10) Pub. No.: US 2019/0166796 A1
(43) Pub. Date: Jun. 6, 2019

(54) FIRE-RETARDANT ANIMAL APPAREL

(71) Applicant: Dalia MacPhee, Los Angeles, CA (US)

(72) Inventor: Dalia MacPhee, Los Angeles, CA (US)

(21) Appl. No.: 16/272,920

(22) Filed: Feb. 11, 2019

Related U.S. Application Data
(60) Provisional application No. 62/792,060, filed on Jan. 14, 2019.

(51) Int. Cl. A01K 13/00; A01K 29/00

(52) U.S. Cl. CPC A01K 13/006; A01K 29/005

(57) ABSTRACT

The various embodiments herein provide an apparel for covering at least a substantial portion of an animal's body. This apparel has an outer fabric layer made of fire-retardant fibers and attachment devices for securing the apparel to the animal's body. According to an embodiment described herein, the apparel comprises at least one layer made of fire-retardant material selected from a group consisting of polyester and cotton treated with a chemical mix comprising at least one chemical selected from a group comprising proban and phosphorus.

### BACKGROUND

### Technical Field

The embodiments herein generally relate to coverings, blankets and related items and, in particular, to such products adapted to protect animals from injury from fire.

### Description of the Related Art

One of the great dangers that animals, e.g., horses, face is exposure to fire, particularly in a barn or other enclosed area from which the animals, e.g., horses cannot escape without assistance. Often the barn is made of flammable wood and contains very flammable materials such as hay, straw and wood shavings which can be used for bedding. Another danger for animals comes from forest fires. Accordingly, it is desirable to provide animal coverings/apparel that may provide at least some protection against a fire that may seriously harm or kill animals

Often no effective means are provided to protect animals such as horses, dogs, donkeys, etc., from unnecessary and horrific burns incurred during various catastrophes.

Hence, there is a need for an apparel that provides protection from fire and burns along with providing thermal protection for the animal that wears the apparel.

The abovementioned shortcomings, disadvantages and problems are addressed herein and which will be understood by reading and studying the following specification.

### OBJECT OF THE EMBODIMENTS HEREIN

The primary object of the embodiments herein is to provide an apparel that protects the animal from fires or burns.

Another object of the embodiments herein is to provide an apparel that provides thermal protection along with protection from fires or burns.

Yet another object of the embodiments herein is to provide an apparel that includes heat resistant face mask.

Yet another object of the embodiments herein is to provide an apparel that facilitates in locating the position of the animal wearing the apparel.

Yet another object of the embodiments herein is to provide an apparel that is capable of communicating with a user device.

These and other objects and advantages of the embodiments herein will become readily apparent from the following summary and the detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The various embodiments herein provide an apparel for covering at least a substantial portion of an animal's body. This apparel has an outer fabric layer made of fire-retardant fibers and attachment devices for securing the apparel to the animal's body.

According to an embodiment described herein, an apparel comprising at least one layer made of fire-retardant material selected from a group consisting of polyester and cotton treated with a chemical mix comprising at least one chemical selected from a group comprising proban and phosphorus is described.

According to an embodiment described herein, the apparel further comprising an attachment for securing the apparel to the body of the animal is described.

According to an embodiment described herein, the apparel wherein the attachment includes elongate, flexible connecting members made of Velcro is described.

According to an embodiment described herein, the apparel further comprising a face cover capable of providing fire and thermal protection to the face and eyes of the animal wearing the apparel is described.

Accordingly, in one exemplary embodiment, the apparel includes face mask with double mesh heat resistant eye coverings.

According to an embodiment described herein, the apparel is structured to allow the apparel to wrap around the belly of the animal.

According to an embodiment described herein, the apparel further comprising a limb cover capable of providing fire and thermal protection to the face and eyes of the animal wearing the apparel is described. In an exemplary embodiment, the apparel may include boots or limb apparel.

According to an embodiment described herein, the apparel further comprising a subscriber identification module (SIM) embedded within the apparel, the subscriber identification module (SIM) configured for communicating with a user device is described.

According to an embodiment described herein, the apparel further comprising a location tracking unit configured for recording location of the animal wearing the apparel is described.

Alternatively, the apparel may further be imprinted with one of a registration number and a machine-readable code associated with the animal.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates bottom view of the apparel, according to an embodiment described herein.

FIG. 2 illustrates bottom view of the apparel, according to another embodiment described herein.

FIG. 3 illustrates side view of a horse wearing the apparel, according to an exemplary embodiment described herein.

FIG. 4 illustrates side view of a dog wearing the apparel, according to an exemplary embodiment described herein.

FIG. 5 illustrates a schematic diagram showing the communication path between the fire-retardant apparel and the user device, according to an embodiment described herein.

Although the specific features of the embodiments herein are shown in some drawings and not in others. This is done for convenience only as each feature may be combined with any or all of the other features in accordance with the embodiment described herein.

### DETAILED DESCRIPTION OF THE EMBODIMENTS HEREIN

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

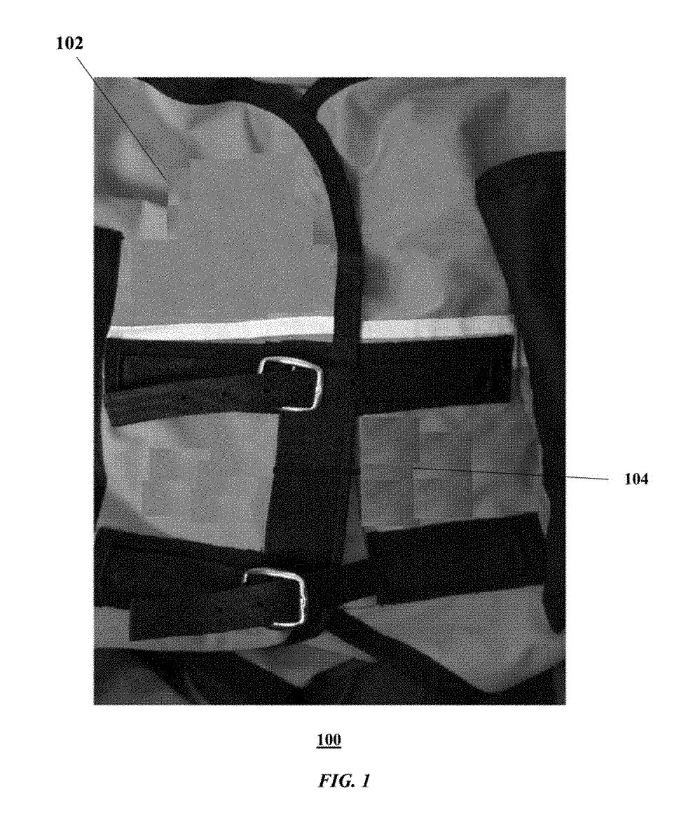

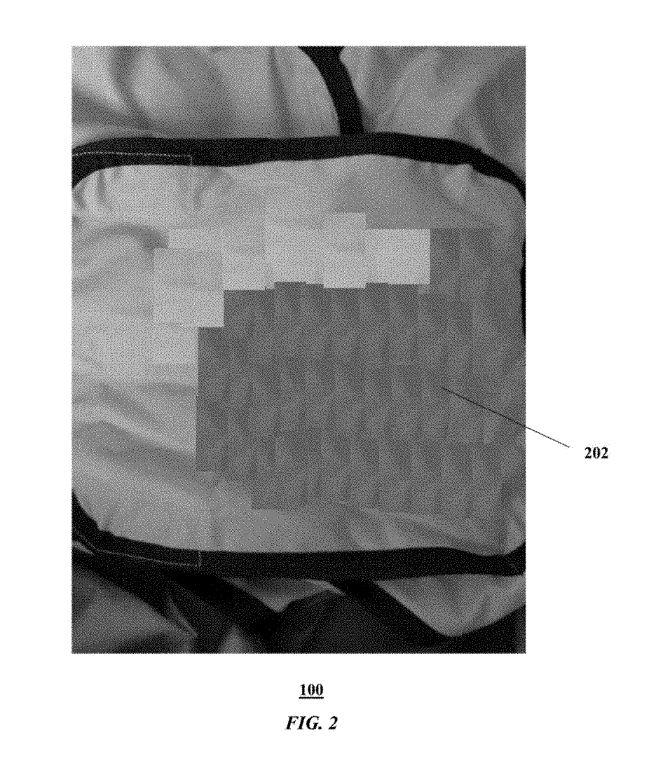

The various embodiments herein provide a fire-retardant apparel 100 (shown in FIG. 1 and FIG. 2) for covering at least a substantial portion of an animal's body. The apparel 100 has an outer fabric layer made of fire-retardant fibers and attachment units for securing the apparel 100 to the animal's body.

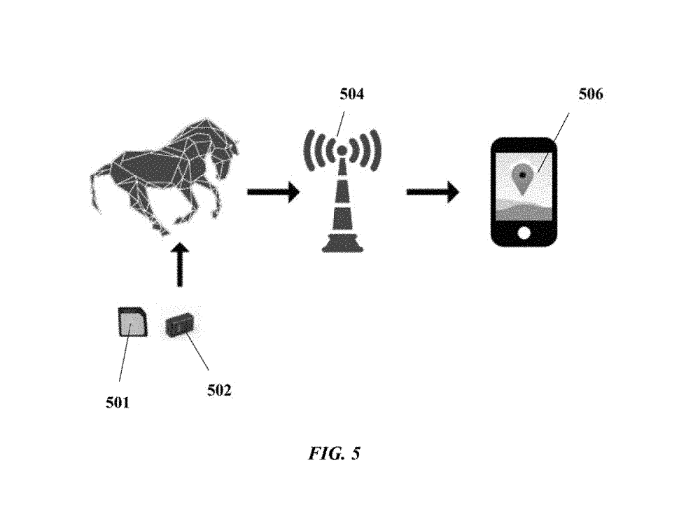

The bottom view of the fire-retardant apparel 100 shown in FIG. 1, shows front chest portion 102 of the apparel 100 along with a pocket/pouch 104 for holding a location tracking unit, which is further explained in conjunction with FIG. 5.

The apparel 100 may further comprise a second covering 202 over chest for providing additional security for the pocket/pouch 104 carrying the location tracking unit that is located underneath the second covering 202.

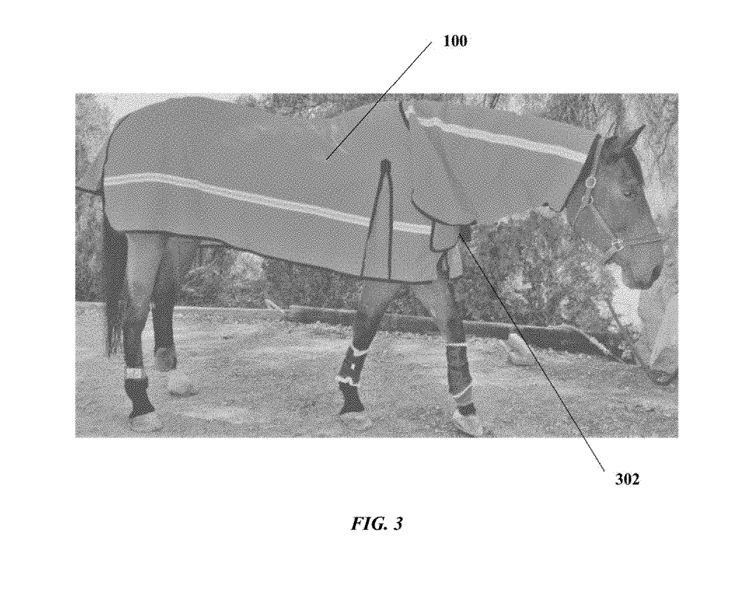

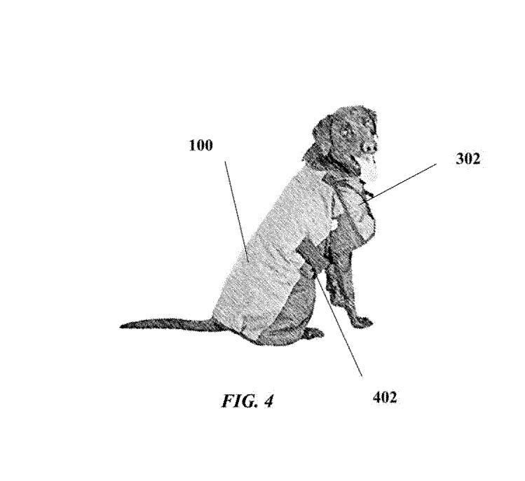

FIG. 3 and FIG. 4 respectively illustrate side view of a horse and a dog wearing the apparel 100, according to an exemplary embodiment described herein. Skilled artisans shall however appreciate that the apparel 100 can be worn by other animals including but not limited to pony, dog and donkey.

According to an embodiment described herein, the apparel 100 comprises at least one layer made of fire-retardant material selected from a group consisting of polyester and cotton treated with a chemical mix comprising at least one chemical selected from a group comprising proban and phosphorus. The phosphorus reflects the heat and flames thereby aiding in emergency evacuation.

In an additional embodiment, the fire-retardant material may be selected from a group consisting of Nomex™, modacrylic, Carbon-X, Kevlar, PBI, silicon treated fiberglass and aramid fibres.

In one exemplary embodiment, the apparel 100 made of fire-retardant material can withstand temperatures of up to 700-degree FH.

The apparel 100 may be manufactured in a variety of colors, for example, bright orange with neon yellow reflective stripes for visibility in smoke and less visibility conditions. The apparel 100 may also be designed to include reflective visibility stripes for easy spotting.

Accordingly, in one exemplary embodiment, the apparel 100 may comprise Silicone treated fiberglass as a top layer, modacrylic cotton as filling, and inside lining of aramid cotton, or Nomex™.

In another exemplary embodiment, the apparel 100 may comprise Silicone treated fiberglass as at least one layer, in order to provide fire retardancy and thermal protection as well, and inside lining of aramid cotton, or aramid polyester, or aramid cotton blend.

According to an embodiment described herein, the apparel 100 further comprises an attachment 302 (shown in FIG. 3 and FIG. 4) for securing the apparel 100 to the body of the animal. The attachment 302 includes elongate, flexible connecting members made of Velcro. Velcro straps are fire resistant and provide additional security and enable apparel wearing in short duration.

In an additional embodiment, the apparel 100 may further include back straps 402 (located behind the hind limbs) that are breakaway clips that facilitate release of the animal in case of occurrence of an untoward incident like getting stuck in a fence or tree or branch by breaking away.

According to an embodiment described herein, the apparel 100 further comprising a face cover capable of providing fire and thermal protection to the face and eyes of the animal wearing the apparel 100 is described.

According to an embodiment described herein, the apparel 100 is structured to allow the apparel 100 to wrap around the belly of the animal.

According to an embodiment described herein, the apparel 100 further comprising a limb cover capable of providing fire and thermal protection to the face and eyes of the animal wearing the apparel 100 is described.

According to an embodiment shown in FIG. 5, the apparel 100 further comprises a subscriber identification module (SIM) 501 embedded within the apparel 100, the subscriber identification module (SIM) 501 configured for communicating with a user device 506 via a communication network 504.

The user device 506 may be a personal computing device, among other things for example, a desktop computer, a laptop computer, a notebook, a netbook, a tablet personal computer (PC), a control panel, a smart phone, a mobile phone, a personal digital assistant (PDA), and/or any other suitable device operable to send and receive data and display data.

The owner or the guardian of the animal associated with the user device 506 may be communicated regarding emergency situations and/or actions to be taken safe upkeeping of the animal.

The protection provided by the apparel 100 should preferably provide at least sufficient protection for the animal for a time that will be long enough to allow the owner, guardian or firemen to come and remove the animal from the barn, cannel or other enclosed area.

According to an embodiment described herein, the apparel 100 further comprises a location tracking unit 502 embedded within the pocket/pouch 104 (shown in FIG. 1) and configured for recording location of the animal wearing the apparel 100.

In one embodiment, the location tracking unit 502 is configured to access global positioning system (GPS) signals and/or signals from other global navigation satellite systems (GNSSs) and/or terrestrial radiofrequency signals. The location tracking unit 502 can generate location information comprising co-ordinates indicating current location of the animal, using at least a portion of such signals.

The location information thus generated may be used to locate and/or track loose or missing animals. The location information is communicated through the SIM 501 embedded within the apparel 100. This will allow the owner to keep in constant contact with the animal, his location, last known location etc.

In an additional embodiment, the location or emergency information may be communicated to an application server that can in turn provide ready information to any user who is authorized to access the application. The application may be hosted on a world wide web.

In one embodiment, in order to accommodate the location tracking unit 502, a zipper pouch is provided preferably at the chest region of the apparel 100 where the location tracking unit 502 can be placed. The pouch is lined with an additional layer of the fabric 104 in order to secure the location tracking unit 502. The location tracking unit 502 thus removably attached to the apparel 100 may be charged when necessary.

Alternatively, the apparel 100 may further be imprinted with one of a registration number and a machine-readable code associated with the animal.

Accordingly, a registration number associated with the animal may be printed on the apparel 100. A mapping between the registration number and contact details of the owner or guardian associated with the animal may be maintained in a database of the application server. In the absence of the location tracking unit 502, the contact details of the owner or the guardian may be obtained after providing the registration number at the application server.

The registration number may also be replaced with a machine-readable code such as a bar code or a Quick Response (QR) code. The machine-readable code may be printed or sewn on the apparel 100 in the form of a reflective strip. The contact details of the owner or the guardian may be obtained after scanning the machine-readable code with the user device 506. The usage of reflective stripe enables scanning of the machine-readable code from a long distance and/or in less visibility conditions.

The advantages of the embodiments disclosed herein comprise providing a cost-effective and simple means of providing fire-retardant animal wear that also provides thermal protection.

The apparel 100 can be used as every day wear or for use in emergency condition such as wild fire, barn fire, where there is threat of fire, to help protect the animals from burning, embers and heat.

The phosphorus reflects the heat and flames thereby aiding in emergency evacuation.

The apparel 100 is also double lined to provide extra thermal heat protection.

The smart animal wear described herein capable of communicating with a user device 506 associated with a user or a guardian of the animal regarding location and/or emergency situations or regarding actions to be taken safe upkeeping of the animal. Another advantage includes usage of natural fibre which facilitates machine wash without losing its efficacy. Yet another advantage includes the animal apparel being water proof can be used for protecting the animal from heat, fire and water.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the appended claims.

It is also to be understood that the following claims are intended to cover all of the generic and specific features of the embodiments described herein and all the statements of the scope of the embodiments which as a matter of language might be said to fall there between.

What is claimed is:

1. An apparel comprising at least one layer made of fire-retardant material selected from a group consisting of polyester and cotton treated with a chemical mix comprising at least one chemical selected from a group comprising proban and phosphorus.

2. The apparel as claimed in claim 1, further comprising an attachment for securing the apparel to the body of the animal.

3. The apparel as claimed in claim 1, wherein the attachment includes elongate, flexible connecting members made of velcro.

4. The apparel according to claim 1, further comprising a face cover capable of providing fire and thermal protection to the face and eyes of the animal wearing the apparel.

5. The apparel according to claim 1, is structured to allow the apparel to wrap around the belly of the animal.

6. The apparel according to claim 1, further comprising a limb cover capable of providing fire and thermal protection to the face and eyes of the animal wearing the apparel.

7. The apparel according to claim 1, further comprising a subscriber identification module (SIM) embedded within the apparel, the subscriber identification module (SIM) configured for communicating with a user device or an application server.

8. The apparel according to claim 1, further comprising a location tracking unit coupled to the subscriber identification module, the location tracking unit configured for recording location of the animal wearing the apparel.

9. The apparel according to claim 1, further imprinted with a registration number associated with the animal.

10. The apparel according to claim 1, further imprinted with a machine-readable code associated with the animal.
